(19) United States
(12) Patent Application Publication
(10) Pub. No.: US 2025/0185698 A1
(43) Pub. Date: Jun. 12, 2025

(54) MEAT-CONTAINING PUFFED PELLET, MEAT-CONTAINING PUFFED FOOD PREPARED THEREFROM, AND PREPARATION METHOD THEREOF

(71) Applicant: PepsiCo Foods (China) Company Limited, Shanghai (CN)

(72) Inventors: Tianzhu Li, Shanghai (CN); Aimin Yang, Shanghai (CN); Huanhuan Lv, Shanghai (CN); Pingping Zhou, Shanghai (CN)

(21) Appl. No.: 18/971,721

(22) Filed: Dec. 6, 2024

(30) Foreign Application Priority Data
Dec. 8, 2023 (CN) 2023116878157

(51) Int. Cl. A23L 13/60; A23L 7/17; A23L 7/191; A23L 13/10; A23L 13/50; A23P 30/34

(52) U.S. Cl. CPC A23L 13/67; A23L 7/17; A23L 7/191; A23L 13/10; A23L 13/52; A23P 30/34

(57) ABSTRACT

A meat-containing puffed pellet, a meat-containing puffed food prepared therefrom, and a preparation method for such are described. The method includes feeding meat into a meat grinder and sequentially passing the meat through a first orifice plate, a double-sided reamer, and a second orifice plate of the meat grinder to obtain minced meat. Thereafter, the minced meat may be fed to an emulsification apparatus for emulsification to obtain emulsified meat, which may then be mixed with grain to form a mixture. The mixture may be feed into an extrusion apparatus for extrusion to obtain meat-containing puffed pellet. The prepared puffed pellet has a high meat content (for example, 42 wt. % or more), uniform distribution, and a loose texture, and it is suitable for subsequent pressure-molding to prepare the puffed food with high meat content and crispy texture.

This application claims priority to Chinese Patent Application No. 202311687815.7, filed Dec. 8, 2023, the entire contents of which is incorporated herein by reference.

The present disclosure relates to the technical field of food processing, in particular to a meat-containing puffed pellet, a meat-containing puffed food prepared therefrom, and a preparation method thereof.

### BACKGROUND

Puffed foods are loose or crispy foods made mainly from grains, potatoes, beans, fruits and vegetables, or nuts and seeds, by using puffing process. The puffing process refers to a process in which raw materials expand in volume or loosen in structure after being heated or subjected to pressure changes. Puffed foods have increasingly become a popular leisure foods among consumers due to their convenient portability and consumption, crispy taste, wide applicability of the raw materials, and various flavors and the like. Common puffed foods include snow rice cakes, potato chips, prawn chips, prawn crackers, popcorns, and rice crackers and the like.

At the present, puffed foods may be roughly divided into a fried type and a non-fried type according to the processing conditions. The fried type puffing is a process of rapidly expanding the volume of materials by placing them in oil at a high temperature. However, it is thought that fried foods may lead to obesity, damage cardiovascular systems, and induce diseases, and long-term consumption of the fried foods may be harmful to the health. Therefore, more and more food manufacturers are committed to using non-fried puffing technology to prepare puffed foods. One common non-fried puffing technology includes direct extrusion. Traditional direct extrusion puffed foods are mainly made from grains, potatoes, or beans. In a direct extrusion process, the driving force of an extruder screw is used to extrude the materials such that the materials are mixed, stirred, rubbed, and subjected to a high shearing force to obtain and accumulate energy so as to reach high temperature and high pressure. Thereafter, the products are directly puffed due to the pressure difference inside and outside the extruder. A possible advantage of this technology is that it may directly provide a puffed expanded product, but usually the main raw material is starch. If meat were to be added to the starch material, the meat particles may be too large to mix evenly with other raw materials; thus. it is difficult to prepare meat-containing puffed products with a crispy taste.

With the development of the social economy, people are increasingly concerned about the taste, nutritional value, and health and safety of leisure foods and, more consumers seek leisure foods that not only have rich taste but also a higher health value.

### SUMMARY

In order to overcome the shortcomings of traditional direct extrusion technologies, the present disclosure provides a meat-containing puffed pellet, a meat-containing puffed food prepared therefrom, and a preparation method thereof, by which the meat content and nutritional value can be enhanced and crispy taste is obtained.

In a first aspect, the present disclosure provides a method for preparing meat-containing puffed pellets. The method of this aspect includes feeding meat into a meat grinder and sequentially passing the meat through a first orifice plate, a double-sided reamer, and a second orifice plate of the meat grinder to obtain minced meat. The double-sided reamer has a plurality of cutting units, with each of the cutting units having two cutting edges arranged parallel to each other. The minced meat may then be fed to an emulsification apparatus for emulsification to obtain emulsified meat. The emulsified meat may be mixed with a grain to form a mixture; which may be feed into an extrusion apparatus for extrusion to obtain a meat-containing puffed pellet.

In a second aspect, the present disclosure provides a meat-containing puffed pellet prepared by the above mentioned method.

In a third aspect, the present disclosure further provides a method for preparing a meat-containing puffed food that includes feeding the meat-containing puffed pellet mentioned above into a chamber of a pressure-molding apparatus; exposing the meat-containing puffed pellet to an increased pressure and temperature inside the chamber for a selected period of time; and rapidly expanding the volume of the chamber to cause a rapid expansion of the contained meat-containing puffed pellet to obtain a puffed chip, that is, the meat-containing puffed food.

In a fourth aspect, the present disclosure provides another method for preparing a meat-containing puffed food that includes providing the meat-containing puffed pellet mentioned above; providing dried meat; mixing the dried meat and the meat-containing puffed pellet to form a mixture; feeding the mixture into a chamber of a pressure molding apparatus; exposing the mixture to an increased pressure and temperature inside the chamber for a selected period of time; and rapidly expanding the volume of the chamber to cause a rapid expansion of the contained mixture to obtain a puffed chip, that is, the meat-containing puffed food.

In a fifth aspect, the present disclosure provides a meat-containing puffed food prepared by the above-mentioned method.

Other features and aspects of the present disclosure are illustrated in more detail below.

### BRIEF DESCRIPTION OF THE DRAWINGS

FIG. 1 shows a mixture of a meat-containing puffed pellet and dried meat prepared by a method according to an embodiment of the present disclosure.

FIG. 2 shows a photograph of a finished meat-containing puffed food prepared by a method according to an embodiment of the present disclosure.

### DESCRIPTION

The present disclosure is further described in detail below, so that those of ordinary skill in the art to which the present disclosure belongs may easily put the present disclosure into practice. However, it should be understood that the present disclosure may be implemented in various forms and is not limited to specific implementation modes described herein, and embodiments of the present disclosure are only examples.

The term “about” or “approximately” used with respect to recited numerical values encompasses both exact values and reasonable variances.

Unless otherwise stated, the terms “include” and “contain” and grammatical variations thereof are intended to indicate an “open” or “inclusive” language, so that it includes listed elements but also allows for the inclusion of additional, unlisted elements.

The term “and/or” as used herein includes one or more related or any combinations of listed items.

Unless otherwise stated, all percentages in the description refer to weight percentages. The expressions “accounting for . . . % by weight”, “weight %”, “% by weight”, “wt. %” are synonymous, and it refers to quantities expressed as the percentages based on the dry weight.

Unless otherwise defined, all terms have and should be endowed with meanings as those commonly understood by those of ordinary skill in the art to which the present disclosure belongs.

### Preparation of Meat-Containing Puffed Pellet

In a first aspect, the present disclosure provides a method for preparing meat-containing puffed pellet, that includes feeding meat into a meat grinder and sequentially passing the meat through a first orifice plate, a double-sided reamer, and a second orifice plate of the meat grinder to obtain minced meat. The double-sided reamer has a plurality of cutting units, with each of the cutting units having two cutting edges arranged parallel to each other. Thereafter, the minced meat may be fed to an emulsification apparatus for emulsification to obtain emulsified meat. The emulsified meat may be mixed with one or more grains to form a mixture, which may be fed into an extrusion apparatus for extrusion to obtain a meat-containing puffed pellet.

In existing technologies, some food manufacturers prepare puffed foods by mixing meat with grains or starch raw materials and extruding it to increase its protein content. However, due to limitations of existing ordinary extrusion technologies, the amount of added meat in the puffed foods is relatively low, the texture is thick, and the taste is bland. If the amount of added meat is too high, it may cause difficult and impossible production due to the excessive amount of water and low temperature of the final mixture of fresh meat and grain raw materials entering a puffing apparatus (an extruder), which results in the final puffed pellets sticking together to form clusters, or are unable to form a pellet, and/or are insufficiently puffed, and the like.

In order to solve the above-mentioned problems in the direct extrusion technology, the present inventors innovatively combined extrusion with pressure-molding, i.e., the puffed pellet may be prepared first by an extrusion process, and then the obtained puffed pellet may be subjected to pressure-molding. In this way, suitable puffed foods for consumers are prepared. However, in order to prepare the described puffed foods with a high meat content and a crispy taste by pressure-molding technology, the meat content, uniformity, size and the like of the puffed pellet used for the pressure-molding are crucial. In addition, due to the presence of a significant proportion of anadesma (such as ligaments, and connective tissues) in meats such as beef and lamb, if not removed, it may lead to excessively large minced meat granularity. Moreover, due to the low shearing setting of the extruders for producing the puffed pellet, if the pre-treated minced meat granularity is too large, its granularity may not be further reduced by subsequent processing, thereby the uniformity of meat in the puffed pellet and the formability of the puffed pellet are affected. In existing technologies, the anadesma may be manually removed or separated from the meat, but this is time-consuming and labor-intensive.

The present disclosure uses a meat grinder with a double-sided reamer to automatically remove the anadesma while the meat is minced resulting in reduced granularity of the minced meat. After removing the anadesma and reducing the granularity of the minced meat, it is further emulsified to achieve lower granularity, so that the mixing with the grains is more uniform. After extrusion, the puffed pellets with high meat content (such as about 42 wt. % or more), uniform distribution, and loose texture can be obtained, which is very suitable for subsequent pressure-molding to prepare the puffed foods with high meat content and crispy taste.

An exemplary double-sided reamer may be a double-sided slotted reamer, which has a plurality of cutting units. In some instances, each of the cutting units may have two cutting edges arranged parallel to each other. In the process of mincing the meat, the double-sided reamer may perform multi-cutting on food materials. Compared with a traditional single edge reamer, a double-sided reamer greatly improves the cutting effect on the food materials and may effectively cut and remove anadesma and cartilage and the like in the meat. In addition, a center hole of the double-sided reamer may be connected to a slag discharging pipe so that when the double-sided reamer may scrape the anadesma and cartilage and the like that may not pass through the orifice plate to the slag discharging pipe, and it is collected into a leftover material bucket by a flexible pipe, thereby the anadesma and cartilage and the like are removed.

In one embodiment of the present disclosure, the double-sided reamer may have four cutting units, with the four cutting units vertically arranged in sequence. During operation, an edge shaft passing through the center hole of the double-sided reamer drives the double-sided reamer to rotate, and all four cutting units are perpendicular to an axis of the edge shaft. The first cutting unit is taken as a reference, the second cutting unit is vertically arranged with the first cutting unit, the third cutting unit is vertically arranged with the second cutting unit, and the fourth cutting unit is vertically arranged with the third cutting unit. At this time, the first cutting unit is perpendicular to the fourth cutting unit, which may ensure the stable rotation of the double-sided reamer so as to evenly cut the food material.

In some embodiments of the present disclosure, an orifice size of the first orifice plate is greater than an orifice size of the second orifice plate. In one embodiment, the orifice size of the first orifice plate may be about 10 mm, and the orifice size of the second orifice plate may be about 6 mm. In this way, meat chunks may be cut twice by the coarse orifice plate (i.e., the first orifice plate) and the fine orifice plate (i.e., the second orifice plate). As a result, a more uniformly minced meat with lower granularity may be obtained.

In some instances, large pieces of thawed meat may be sliced into slices in a meat slicer and then fed into a meat grinder by a feeding screw to be ground into minced meat. In the process of mincing the meat, the raw meat first passes through the first orifice plate (coarse orifice plate) for preliminary cutting, then the meat is further cut by the double-sided reamer. The anadesma and cartilage and the like that are precluded from passing through the second orifice plate are scraped to the slag discharging pipe, with the meat passing through the second orifice plate (fine pore plate) for secondary cutting, to obtain the uniform and finely ground minced meat without the anadesma and cartilage and the like.

Then, the minced meat without the anadesma and cartilage and the like is fed into an emulsification apparatus for emulsification, and fibers in the minced meat are emulsified to further reduce the granularity of the minced meat. As a result, there are few, if any, limitations on the type of meat that may be used and, even high-fiber meats (such as beef, and lamb) may be successfully prepared into the uniform puffed pellet that meets the requirements. In some embodiments, the emulsification apparatus is a high-speed shearing emulsifier, and its rotation speed is about 3000 rpm. The working principle of the high-speed shearing emulsifier is to use the relative high-speed motion of rotor and stator edges to generate a high shearing force, which reciprocates the materials to achieve efficient mixing, dispersion, and emulsification effects. In some embodiments, in order to provide a suitable emulsification, a gap between the stator edge and the rotor edge of the emulsification apparatus is less than about 0.6 mm. It has been found that when the gap between the stator edge and the rotor edge is smaller, the generated shearing force is larger, and the emulsification effect is better.

In addition, an emulsifier may be added during the emulsification process to assist in the emulsification of the minced meat. The emulsifier refers to a substance that may improve the surface tension between various constituent phases in an emulsion system, to form a uniform dispersion or emulsion. Emulsifier molecules with electric charges may charge the surface of droplets to form a double electric layer, enhance the electrostatic repulsion between the droplets, and reduce the probability of droplet collision and coalescence. Suitable non-limiting examples of emulsifiers that may be used in the described method include, one or more of mono- and diglyceride fatty acid esters, polyglycerol fatty acid ester, sucrose fatty acid, soybean phospholipids and the like. In some embodiments, the emulsifier may be a monoglyceride fatty acid ester and/or a diglyceride fatty acid ester. After the above emulsification, the granularity of the minced meat may be controlled to be less than about 1.5 mm, or even less than about 0.6 mm. Within these ranges, the minced meat is suitable for subsequent processes such as mixing with the grains, extrusion, and slicing.

Next, the emulsified minced meat may be fed into a conditioner for preheating, so as to prevent the minced meat from gathering into clumps and so the minced meat will evenly mix with the grains. In some embodiments, the preheating temperature may be controlled at about 70° C. to about 85° C., and the time may be set to about 2 to about 4 minutes. If the temperature is too low, the minced meat may form clumps and, if the temperature is too high, the minced meat may be cooked into chunks. Therefore, controlling the preheating temperature within the noted range may further improve the mixing effect of the minced meat and grains. Certainly, it may be understood that in other embodiments, the preheating may not be required according to the actual situation and needs, and it is not limited here.

Then, the grains and other raw materials may be added to the conditioner and mixed with the preheated (or non-preheated) minced meat to form a mixture. In the process of mixing, water or steam may be injected into the conditioner, while the temperature may be controlled within a range of about 60° C. to about 100° C. to further aid in uniformly mixing of the minced meat and other raw materials such as the grains, and the water content is controlled for subsequent extrusion. Water may be injected into the conditioner by well-known apparatus in this field, such as a peristaltic pump, a plunger pump, a metering pump, a screw pump, and a rotor pump. The amount of the water added to the mixture may be adjusted according to needs, as long as there is a sufficient but not excessive amount to that the mixture may be shaped.

Subsequently, the mixed materials (i.e., the meat and grains) are fed into an extrusion apparatus for extrusion to obtain the meat-containing puffed pellet.

As used in the present disclosure, “extrusion” refers to a processing technology that integrates mixing, stirring, crushing, heating, steaming, sterilizing, puffing, and shaping, and may achieve a series of unit operations simultaneously and continuously. When the mixed materials are fed into the extrusion apparatus, the mixed materials are moved forward under the pushing action of the screw and spiral. At the same time, due to the mechanical friction between the spiral and the mixed materials, the mixed materials and a machine barrel, the material is extruded, stirred, and sheared, and further refined and homogenized. As the internal pressure of a machine cavity is gradually increased, the temperature correspondingly rises. Under the conditions of high temperature, high pressure, and high shearing force, the material properties are changed from a powder to a paste, starch undergoes gelatinization and cracking, proteins undergo denaturation and recombination, and fibers undergo partial degradation and refinement. At the moment when the paste-like material is ejected from a mold hole, under the strong pressure difference, the water is rapidly evaporates, and the material is puffed, to form a loose, porous, and crispy puffed product.

In the preparation method of the present disclosure, the extrusion apparatus may be any suitable apparatus known in this field, such as a single-screw extruder, a twin-screw extruder, or a multi-screw extruder. The screw extruder relies on the pressure and shearing force generated by the rotation of the screw, which may fully plasticize and uniformly mix the materials, and form it by the mold surface. In some embodiments, for example, a twin-screw extruder may be used.

It has been found by the inventors that by adjusting the extrusion process conditions, it is possible to successfully prepare a puffed pellet with a high meat content by using an extrusion apparatus, and then to successfully prepare a chip having a crispy taste by further pressure-molding. In some embodiments, the conditions for extrusion may be, for example, a temperature of about 60° C. to about 120° C. and a time of about 10 to about 60 s. In some embodiments, the conditions for extrusion may be, for example, a temperature of about 110° C. and a time of about 20 s. In some embodiments, the conditions for extrusion may be, for example, a temperature of about 80° C. to about 100° C. and a time of about 20 to about 40 s. In some embodiments, the conditions for extrusion may be, for example, a temperature of about 85° C. and a time of about 30 s.

It should be noted that in the described method, any suitable methods and apparatus known in this field may be used for mixing the raw materials during the mixing process. For example, in some embodiments, the mixture containing grains and meat may be directly fed into the extrusion apparatus for mixing, or they may be mixed by using a mixer or a paddle dough mixer or the like. The mixing rotation speed, mixing time, and mixing weight may be adjusted by those skilled in the art, as needed.

Since the puffed material discharged from the extrusion apparatus is generally in the form of strips, the strip-like puffed material may be sliced by a slicer, to obtain uniformly sized (for example, less than about 10 mm) puffed pellets. Specifically, the rotation speed of the slicer may be about 2500 to about 3000 r/min. The rotation speed of the slicer may be adjusted appropriately according to the product volume weight requirements, and it is not limited. In addition, due to the higher temperature and viscosity of the puffed material discharged from the extrusion apparatus, in order to avoid adhesion to the slicer during the slicing process, the puffed material may be cooled before slicing to reduce its viscosity. For example, the cooling temperature may be controlled at about 5° C. to about 10° C., but it is not limited to this and may be adjusted appropriately according to the actual situation.

In order to facilitate subsequent pressure-molding, the puffed pellet obtained from slicing may also be dried, so as to control the water content of the puffed pellet within an appropriate range, such as about 8 wt. % to about 20 wt. %. In some embodiments, the water content of the puffed pellet may be about 10 wt. % to about 18 wt. %. In some embodiments, the water content of the puffed pellet may be about 12 wt. % to about 16 wt. %. In some embodiments, the water content of the puffed pellet may be about 8 wt. %. In the present disclosure, any methods known in this field may be used to dry the puffed pellet, as long as the water content of the puffed pellet may be controlled within the above appropriate range. In some embodiments, drying may be performed by baking, for example, it is dried in a circulating oven at about 90° C. to about 120° C. for about 45 to about 120 min. It may be understood that the temperature and time of baking may be adjusted appropriately according to actual needs, and it is not limited here. In order to provide for uniform size and color of the puffed pellet used for the subsequent pressure-molding, sieving may be performed by using a sieving machine (such as a φ8 mm (a number 8) sieve) or a color sorter (such as a three-color sorter), so as to achieve the desired quality of the final puffed food product.

It has been found by the inventors that the amount of added meat in the puffed pellet may affect the subsequent formation of the puffed food. In some embodiments of the present disclosure, the amount of meat in the puffed pellet may be from about 5 wt. % to about 60 wt. %. In some embodiments, the amount of meat in the puffed pellet may be form about 20 wt. % to about 30 wt. %. In some embodiments, the amount of meat in the puffed pellet may be from about 30 wt. % to about 50 wt. %. In one embodiment, the amount of meat in the puffed pellet may be about 38 wt. %. By adjusting the meat addition amount of the puffed pellet, a puffed chip with high meat content and crispy taste can be obtained by the subsequent pressure-molding.

In addition, in order to facilitate forming and improving nutrition and flavor, in some embodiments, the puffed pellet may also include at least one of protein powder, beans, edible starch, food additives, nutritional fortifiers, seasonings and the like.

The protein powder suitable for use in the present disclosure may be a plant-based protein powder, animal-based protein powder, mixed protein powder, and mixtures thereof. For example, it may be selected from one or more of soy protein powder, collagen powder, corn protein powder, peanut protein powder, whey protein powder, egg protein powder, pea protein powder, brown rice protein powder and mixtures thereof. The edible starch suitable for use in the present disclosure may be selected from one or more of corn starch, rice starch, potato starch, wheat starch, sweet potato starch, cassava starch, green bean starch and mixtures thereof. The food additive suitable for use in the present disclosure may be selected from one or more of a flavor enhancer, a bulking agent, a food pigment, a preservative, a sweetener, an edible essence and mixtures thereof. The edible essence may be selected from one or more of onion flavor essence, citrus flavor essence, fruit flavor essence, mint flavor essence, bean flavor essence, spicy flavor essence, milk flavor essence, meat flavor essence, nut flavor essence, wine flavor essence, vegetable flavor essence and mixtures thereof. The nutritional fortifier suitable for use in the present disclosure may be selected from one or more of astaxanthin, glutathione, fermented bran extract, vitamin, dairy product, trace element and mixtures thereof. The seasoning suitable for use in the present disclosure is as defined above.

Other auxiliary materials may also be added to the mixture, such as one or more additives, including but not limited to nitrogen source proteins, amino acids, carbohydrate sources, saturated or unsaturated fatty acids, plant extracts, sterols, defoamers, pigments, and other additives. In some embodiments, the cereal mixture may contain maltodextrin and B-carotene. In some embodiments, the mixture may contain turmeric or other functional ingredients such as DHA powder, phytosterol esters, phosphatidylserine, and mulberry leaf extract.

As used herein, the term “beans” refers to seeds of leguminous soybean plants. Beans suitable for use in the present disclosure may include, but are not limited to, soybeans, broad beans, red beans, green beans, yellow beans, black beans, cowpeas, peas, sword beans, hyacinth beans, kidney beans, chickpeas, pigeon peas and mixtures thereof. In some embodiments, the beans may be selected from at least one or more of soybeans, broad beans, red beans, green beans, yellow beans, black beans and mixtures thereof. In some embodiments, the beans may be soybeans, for example. The form of beans is not particularly limited and may be adjusted as needed, it includes but is not limited to powder, granules, flakes, suspensions, chunks and the like. In some embodiments, the beans may be powder, granules, flakes, or chunks or the like. In some embodiments, the beans may be in powder form.

As used herein, the term “grains” refers to monocotyledonous or dicotyledonous plants grown for its edible seeds, it includes plants selected from Oryza and Triticum of Poaceae and combinations thereof. The grains suitable for use in the present disclosure may be selected from, for example, rice, millet, corn, wheat, oat, barley, sorghum and mixtures thereof. In some embodiments, the grains are selected from at least one of rice, corn, wheat and mixtures thereof. In some embodiments, the grains may be rice.

The form of the grains is not particularly limited and may be adjusted as needed. The form includes, but is not limited to, powder, granules, flakes, suspensions, chunks and the like. In some embodiments, the grains may be in the form of powder, granules, flakes, or chunks. In some embodiments, the grains may be in powder form.

In a second aspect, the present disclosure provides a meat-containing puffed pellet prepared by the above-mentioned method. The meat-containing puffed pellet prepared has high meat content, uniform distribution, and crispy texture, and it is very suitable for the subsequent pressure-molding to prepare the puffed food with high meat content and crispy taste. In some embodiments, the raw material for preparing the meat-containing puffed pellet may contain about 5 wt. % to about 60 wt. % of grains, about 5 wt. % to about 60 wt. % of meat, about 0 wt. % to about 20 wt. % of beans, about 0 wt. % to about 25 wt. % of protein powder and about 0 wt. % to about 45 wt. % of edible starch. In some embodiments, the raw material for preparing the meat-containing puffed pellet may contain about 20 wt. % of grains, about 60 wt. % of meat, about 5 wt. % of protein powder, about 5 wt. % of beans, about 8.5 wt. % of edible starch and about 1.5 wt. % of food additives.

### Method for Preparing Meat-Containing Puffed Food

In a third aspect, the present disclosure further provides a method for preparing a meat-containing puffed food that includes feeding the meat-containing puffed pellet mentioned above into a chamber of a pressure-molding apparatus; exposing the meat-containing puffed pellet to an increased pressure and temperature inside the chamber for a selected period of time; and rapidly expanding the volume of the chamber to cause a rapid expansion of the contained meat-containing puffed pellet to obtain a puffed chip, that is, the meat-containing puffed food. The prepared meat-containing puffed food has crispy taste and rich nutrition.

In a fourth aspect, the present disclosure further provides a method for preparing a meat-containing puffed food that includes providing the meat-containing puffed pellet mentioned-above; providing dried meat; mixing the dried meat and the meat-containing puffed pellet to form a mixture; feeding the mixture into a chamber of a pressure-molding apparatus; exposing the mixture to an increased pressure and temperature inside the chamber for a selected period of time; and rapidly expanding the volume of the chamber to cause a rapid expansion of the contained mixture to obtain a puffed chip, that is, the meat-containing puffed food. By using this method, the meat content of the finished product may be further increased (based on the total weight of the meat-containing puffed food, the total meat addition amount may be greater than about 5 wt. %), the puffed food in which meat is visibly embedded in a meat-containing base is prepared, and it has composite taste and rich meat aroma.

Since the main raw materials of the containing-meat puffed food of the present disclosure are grains and meat, the grains contain high-quality vegetable proteins, which play an important role in preventing metabolic diseases (such as obesity, diabetes, and hyperlipidemia) and cardiovascular diseases, and maintaining intestinal health and the like. The meat is rich in animal proteins, and contains various amino acids needed by the human body and has high nutritional value. The pressure-molding process of the present disclosure may bring a crisp and thin taste, and it contains rich plant proteins and animal proteins, and has high nutritional value.

As described above, the puffed pellet obtained by slicing may be dried to control its water content. In the fourth aspect of the present disclosure, the water content of the puffed pellet and dried meat is modulated to achieve a desirable puffed chip. Accordingly, in some embodiments, the water content of the puffed pellet may be about 8 wt. % to about 20 wt. %. In some embodiments, the water content of the puffed pellet may be about 10 wt. % to about 18 wt. %. In some embodiments, the water content of the puffed pellet may be about 12 wt. % to about 16 wt. %. In some embodiments, the water content of the puffed pellet may be about 8 wt. %. In some embodiments of the present disclosure, the water content of the dried meat may be about 10 wt. % or less. In some embodiments, the water content of the dried meat may be about 8 wt. % or less. In some embodiments, the water content of the dried meat may be about 6 wt. % or less. If the water content of the puffed pellet is too high, it may cause the pellets to adhere and form clusters, and it may be difficult to shape. On the other hand, if the water content of the puffed pellet and dried meat is too low, it may cause the dried meat to have difficulty in fully adhering to the meat-containing chip during the subsequent pressure-molding process. To this end, the inventors found that modulating the water content of the puffed pellet and dried meat within the above-mentioned range, will allow the puffed pellet to be formed with complete embedding of meat into the meat-containing base. At the same time, the finished product will not adhere to a consumer's teeth, will have thin and crispy texture, and a rich meat aroma when consumed.

As used in the present disclosure, “pressure-molding (compressed popping)” is a food processing technology, which typically uses electric heating as a heat source, by bringing upper and lower molds closer to each other, a material placed in a chamber defined by the upper and lower molds and a usually fixed ring mold is compressed, and then the upper and lower molds are moved away from each other to rapidly expand the volume of the chamber to cause a rapid expansion of the contained material to obtain the puffed product. For example, by using a hydraulic cylinder to drive the upper and lower molds to move towards each other and heat the upper and lower molds, the material to be processed may be compressed and heated, and then the upper and lower molds may be moved away from each other. Since the material is already heated to a high temperature and the moving speed of the upper and lower molds is fast enough, it may cause the free water inside the material to quickly vaporize under high-temperature air baking at this moment, thereby the material is expanded. Compared with the extrusion technology, this processing mode has a larger specific surface area of the material in contact with the air, thus the vaporization of the material is more uniform, and a thinner and more brittle chip product can be prepared.

In some embodiments, the step of exposing the mixture to an increased pressure and temperature inside a chamber for a selected period of time includes: exposing the mixture to an increased pressure inside the chamber for 0.1 to about 3 s, and baking at a temperature of about 200° C. to about 300° C. for about 0.1 to about 3 s. In some embodiments, the step of exposing the mixture to an increased pressure and temperature inside the chamber for a selected period of time includes: exposing the mixture to an increased pressure inside the chamber for about 0.3 to about 1.2 s, and baking at a temperature of 220° C. to about 280° C. for about 0.5 to about 2.5 s. In some embodiments, the step of exposing the mixture to an increased pressure and temperature inside the chamber for a selected period of time includes exposing the mixture to an increased pressure inside the chamber for about 0.5 to about 2 s, and baking at a temperature of 220° C. to about 250° C. for about 1 to about 2 s. The steps of pressurizing, baking, and expanding may be repeated as needed for the puffed chip obtained after expansion, for example, for about 1 to about 3 times. In one embodiment, the step of exposing the mixture to an increased pressure and temperature inside the chamber for a selected period of time includes: exposing the mixture to an increased pressure inside the chamber for about 0.3 s, and baking at a temperature of about 230° C. for about 2 s, and repeating the steps of pressurizing, baking, and expanding of the puffed chip obtained after expansion once. According to the above-mentioned embodiment, by optimizing process parameters of the pressure-molding, the water content of the puffed chip obtained may be about 3 wt. % about 10 wt. %, for example, about 4 wt. %, The volume density may be about 30 g/L to about 80 g/L, for example, about 60 g/L. In this way, chips with a non-stick texture and crispy taste can be obtained. It has been found by the inventors that according to the disclosed methods, by controlling the water content of the puffed pellet and dried meat while appropriately controlling the process conditions of the pressure-molding, the prepared meat-containing puffed food has a more loose and/or puffy and crispy taste.

It has also been found by the inventors that by adjusting the mixing ratio of dried meat and puffed pellet, and by using the pressure-molding apparatus for the pressure-molding, the dried meat may be adhered to the puffed pellet as a whole, and after being sliced, the puffed chip in which the meat is visibly adhered to the meat-containing base can be obtained. Due to the presence of a certain amount of the meat in the meat-containing base, the puffed chip obtained has high meat content, rich meat aroma, and composite taste. By adjusting the mass ratio of the dried meat and puffed pellet within an appropriate range, the adhesion of the meat and the crispy taste of the puffed chip can also be achieved. In some embodiments, the mass ratio of the dried meat and the puffed pellet may be not greater than 1:5. In some embodiments, the mass ratio of the dried meat and the puffed pellet may be not greater than 1:8. In some specific embodiments, the mass ratio of the dried meat and the puffed pellet may be about 1:10. Within these rations, the meat may be completely, uniformly, and firmly embedded in the puffed chip, and the resulting puffed chip is crispy in taste.

In order to further improve the adhesion of the meat, the sizes of both the dried meat and the puffed pellet may be controlled to about 10 mm or less, which helped to provide a puffed pellet is evenly mixed with the dried meat, to obtain crispy chips having meat uniformly embedded in the base and desired thickness (for example, about 1 to about 8 mm).

In some embodiments of the present disclosure, the dried meat may be obtained by drying fresh or pre-made meat. In some embodiments, the preparation of the pre-made meat may include pre-treating fresh meat with at least one of edible starch, food additives, and seasonings, such as marinating, seasoning, and stir-frying, to further improve the adhesion of the meat and enhance the flavor of the dried meat. For example, a whole piece of cleaned fresh meat may be marinated in sauce made of edible starch, food additives, or seasonings or the like for a period of time, and then cut into diced meat by a meat cutting apparatus (such as a meat grinder) and dried. Alternatively, the whole piece of cleaned fresh meat may be cut into diced meat, and then mixed with sauce and marinated for a period of time before drying. In this way, the dried meat with rich flavor and a certain degree of maturity may be obtained, it is convenient to subsequently obtain crispy chips having meat visibly embedded in the meat-containing base and composite taste by the pressure-molding.

In the present disclosure, any methods known in this field may be used to dry the meat, as long as the water content of the meat may be controlled within an appropriate range (for example, about 10 wt. % or less). In some embodiments, the drying may be performed by baking or freezing, for example, after the seasoning or stir-frying is performed on the meat, the drying may be performed by microwave, hot air, or freezing or the like. By drying the meat to control its water content, for example, about 10 wt. % or less, it is convenient for subsequent pressure-molding with the puffed pellet to firmly adhere to the puffed chip.

The puffing process of the present disclosure does not involve frying, thereby the obtained puffed food is healthier and safer.

In order to further improve the texture of the puffed chip, after the pressure-molding, the obtained puffed chip may be further dried, and the water content of the dried puffed chip may be about 6 wt. % or less, for example, about 4 wt. %. This may make the puffed chip crispier.

In some embodiments of the present disclosure, the obtained puffed chip may also be seasoned, for example, seasoning slurry such as oil and seasoning may be coated onto the puffed chip, thereby the flavor of the puffed food may be improved. Any coating methods known in this field may be used, as long as the seasoning slurry may be evenly coated onto the puffed chip. In some embodiments, the oil and seasoning may be mixed into slurry, and the slurry may be sprayed onto the surface of the puffed chip, and dried. In one instance, the oil and seasoning may be mixed into a seasoning slurry by a slurry mixing apparatus, and the seasoning slurry may be sprayed onto the surface of the puffed chip after the pressure-molding by a spray nozzle. In some embodiments, an oil may first be sprayed onto the surface of the puffed chip, and then the seasoning may be sprayed onto the surface of the puffed chip. In other words, oil may be first sprayed onto the surface of the puffed chip after the pressure-molding by an oil spraying apparatus, and then the seasoning may be sprayed onto the surface of the puffed chip by a seasoning spraying apparatus. In this way, the seasoning slurry may penetrate the puffed chip, thus endowing it with a rich flavor.

It may be understood that the amount of oil and seasoning may be determined and adjusted according to actual needs, and the types of the oil and seasoning may also be selected according to the needs. For example, the oil may be vegetable oil or animal oil. The vegetable oil may be selected from, for example, rapeseed oil, peanut oil, hemp oil, corn oil, olive oil, camellia oil, palm oil, sunflower seed oil, soybean oil, sesame oil, flaxseed oil, grape seed oil, walnut oil, peony seed oil, and mixtures thereof. According to the desired flavor, the seasoning may be selected from, for example, one or more of salt, sugar, monosodium glutamate, vinegar, pepper, paprika powder, dried ginger, chili powder, star anise, clove, bay leaf, cinnamon, five spice powder, thirteen spice, curry powder, seven flavor powder, soy sauce, cooking wine, edible essence, and compound seasoning. The seasoning may be selected appropriately according to the needs, without any special limitations.

The “meat” mentioned herein may be selected from at least one of chicken, pork, beef, lamb, duck, freshwater aquatic products, seafood, and mixtures thereof. The meat in the puffed pellet and the meat in the dried meat may be the same or different, and may be selected appropriately according to the needs.

It should be noted that the term “puffed chip” used herein is only for ease of description and is not intended to limit its shape to be slice. Those skilled in the art may understand that the meat-containing puffed food of the present disclosure may also be in other shapes such as hollow strips, and chunks, as long as it has the crispy texture. In the case that the meat-containing puffed food of the present disclosure is a thin slice, the preparation process of the puffed chip further may further include a step of forming slice.

Usually, the prepared meat-containing puffed foods may also be quantitatively packaged. According to the needs, the puffed foods may be packaged in bags, boxes, or cans without any special limitations.

In a fifth aspect, the present disclosure provides a meat-containing puffed food prepared by the above-mentioned method. The prepared meat-containing puffed food contains visible meat embedded in a meat-containing base, and has rich meat aroma, compound taste, non-stick texture, and crispy and thin texture.

In some embodiments, the raw materials for preparing the meat-containing puffed food may include from about 30 wt. % to about 98 wt. % of puffed pellet, about 1 wt. % to about 30 wt. % of dried meat and about 1 wt. % to about 40 wt. % of seasoning slurry. In some embodiments, the raw materials for preparing the meat-containing puffed food may include about 60 wt. % of puffed pellet, about 20 wt. % of dried meat, about 15 wt. % of vegetable oil and about 5 wt. % of seasoning.

According to the above embodiments, the water content of the meat-containing puffed food may be about 1 wt. % to about 6 wt. %, and the texture is non-sticky, thin, and crispy.

It may be understood that the meat-containing puffed food of the present disclosure may be prepared into various flavors or forms, to meet the needs of different consumers. In some embodiments of the present disclosure, the meat-containing puffed food may be, for example, chicken breast chips, beef chips, pork chips, mutton chips, prawn crackers, and fish chips. In some embodiments, the meat-containing puffed food may be, for example, chicken breast chips.

Below, the meat-containing puffed food and the preparation method thereof according to the present disclosure are described in detail in combination with specific examples, but the present disclosure is not limited to these examples. Unless otherwise specified, the raw materials and chemicals in the following examples are of food grade and come from commercially available products.

### Example 1: Preparation of Minced Chicken

Large pieces of thawed were sliced into slices in a meat slicer, and then fed into a meat grinder by a feeding screw for crushing, to obtain uniform and finely minced chicken without anadesma and cartilage and the like.

### Example 2: Preparation of Minced Beef

Large pieces of thawed beef were sliced into slices in a meat slicer, and then fed into a meat grinder by a feeding screw for crushing, to obtain uniform and finely minced beef without anadesma and cartilage and the like.

### Example 3: Preparation of Chicken Chip

A mixture of about 20 wt. % of rice meal, about 60 wt. % of the minced chicken prepared in Example 1, about 5% of soybean meal, about 5 wt. % of protein powder, about 8.5 wt. % of edible starch and about 1.5 wt. % of a food additive was evenly mixed with an appropriate amount of water and fed into a twin-screw extruder, and extruded and puffed at a temperature of about 85° C. for about 30 s, and then dried at a temperature of about 100° C. for about 30 min, to obtain chicken puffed pellets, and the size of the pellets was about 4 mm, and the water content was about 10%.

Fresh chicken breast was taken, and an appropriate amount of a seasoning was added to enhance its flavor. It was cut into diced chicken and dried with hot air until the water content was about 10% or less, to obtain dried diced chicken with size of about 4 mm.

The dried diced chicken and the above-described chicken puffed pellets were thoroughly mixed in a mass ratio of about 1:8 dried diced chicken to above-described chicken puffed pellets, and fed into a pressure-molding apparatus by a feeder for pressure-molding, the puffing condition were as follows: the temperature was about 220° C., the pressure action time was about 2 s, the baking time was about 1 s, it was compressed twice, sliced, and dried at a temperature of about 130° C. to obtain puffed chips with the water content of about 4%, then discharged.

Vegetable oil was sprayed onto the surface of the puffed chips by an oil spraying apparatus, and then the seasoning was sprayed onto the surface of the puffed chips by a seasoning spraying apparatus. The seasoned puffed chips were dried to obtain chicken breast chips.

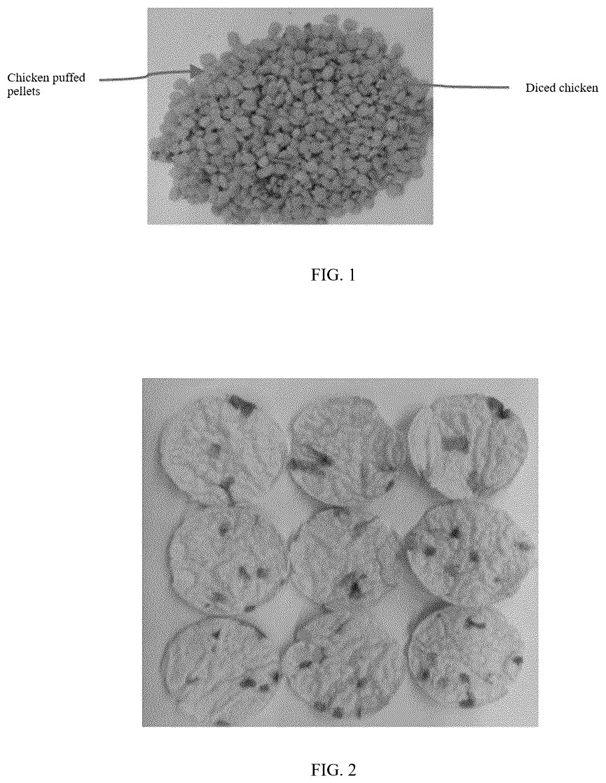

FIG. 1 shows a mixture of the chicken puffed pellets and dried diced chicken prepared in this example, and FIG. 2 shows a photograph of the chicken chips prepared in this example. The chicken chips prepared in this example have good slicing rate (the average yield is about 83% or more), the meat content is about 30% or more, and the water content is about 2%. The chicken is clearly and visibly embedded on the chip, which has rich meat aroma, composite taste, and crispy texture.

### Example 4: Preparation of Beef Chip

A mixture of about 30 wt. % of rice meal, about 30 wt. % of the minced beef prepared in Example 2, about 20% of soybean meal, about 3 wt. % of protein powder, about 15 wt. % of edible starch and about 2 wt. % of a food additive was evenly mixed with an appropriate amount of water and fed into a twin-screw extruder, and extruded and puffed at a temperature of about 110° C. for about 20 s, and then dried at a temperature of about 120° C. for about 10 min, to obtain puffed beef pellets. The puffed beef pellet size was about 6 mm, and the water content was about 15%.

Fresh beef was taken, and an appropriate amount of a seasoning was added to enhance its flavor. It was cut into diced beef and dried with hot air until the water content was about 10% or less, to obtain dried diced beef with the size of about 7 mm.

The dried diced beef and the puffed beef pellets were thoroughly mixed in a mass ratio of about 1:8 dried diced beef to puffed beef pellets, and fed into a pressure-molding apparatus by a feeder for pressure-molding. The puffing conditions were as follows: the temperature was about 200° C., the pressure action time was about 3 s, the baking time was about 1 s, it was compressed once, sliced, and dried at a temperature of about 105° C. to obtain puffed chips with a water content of about 5%, then discharged.

Vegetable oil was sprayed onto the surface of the puffed chips by an oil spraying apparatus, and then the seasoning was sprayed onto the surface of the puffed chips by a seasoning spraying apparatus. The seasoned puffed chips were dried to obtain beef chips.

The beef chips prepared in this example have good slicing rate (the average yield is about 83% or more), the meat content is about 30% or more, and the water content is about 2%. The beef is clearly and visibly embedded on the chip, which has rich meat aroma, composite taste, and loose and crispy texture.

The term “yield” refers to a proportion of good chips that do not have coking, black spots, non-puffing, crushing, deformation, and other conditions to the total chips.

The above-mentioned examples only describe some of a plurality of implementation modes of the present disclosure, and its descriptions are more specific and detailed, but it should not be understood as limiting the scope of the present disclosure. It should be pointed out that for those of ordinary skill in the art, a plurality of modifications and improvements may also be made without departing from the inventive concept, which are all within the scope of protection of the present disclosure. Therefore, the scope of protection of the present disclosure should be based on the appended claims.

1. A method for preparing meat-containing puffed pellet, comprising:
feeding meat into a meat grinder to obtain minced meat;
feeding the minced meat to an emulsification apparatus for emulsification to obtain emulsified meat;
mixing the emulsified meat with grain to form a mixture; and
feeding the mixture into an extrusion apparatus for extrusion to obtain meat-containing puffed pellet.

2. The method according to claim 1 wherein the meat upon entering the meat grinder sequentially passes through a first orifice plate, a double-sided reamer, and a second orifice plate, wherein the double-sided reamer has a plurality of cutting units, with each of the cutting units having two cutting edges arranged parallel to each other.

3. The method according to claim 2, wherein an orifice size of the first orifice plate is larger than an orifice size of the second orifice plate.

4. The method according to claim 3, wherein the first orifice plate has an orifice size of 10 mm and the second orifice plate has an orifice size of 6 mm.

5. The method according to claim 2, wherein the double-sided reamer has four cutting units that are vertically arranged in sequence.

6. The method according to claim 2, wherein a central hole of the double-sided reamer is connected to a slag discharging pipe for discharging meat slags that cannot pass through the second orifice plate.

7. The method according to claim 2, wherein a distance between the two cutting edges arranged parallel to each other is 10 mm.

8. The method according to claim 1, wherein the extrusion is performed at a temperature of about 60° C. to about 120° C. for a period of time of about 10 s to about 60 s.

9. The method according to claim 1, wherein the meat-containing puffed pellet has at least 42 wt. % meat.

10. The method according to claim 1, wherein the meat-containing puffed pellet has a water content of about 8 wt. % to about 20 wt. %.

11. The method according to claim 1, wherein each meat-containing puffed pellet has a size of about 10 mm or less.

12. The method according to claim 1, wherein the emulsified meat has a particle size of less than about 1.5 mm.

13. The method according to claim 1, wherein an emulsifier is added during the emulsification.

14. The method according to claim 1, further comprising feeding the emulsified meat into a conditioner and preheating to 70° C. to about 85° C., after the emulsification and before mixing with the grain.

15. The method according to claim 1, wherein the meat-containing puffed pellet further comprises at least one of protein powder, beans, edible starch, food additives, nutritional fortifiers and seasonings.

16. The method according to claim 15, wherein the edible starch is selected from the group consisting of corn starch, rice starch, potato starch, wheat starch, sweet potato starch, tapioca starch, mung bean starch, and mixtures thereof.

17. The method according to claim 1, wherein the grain is selected from the group consisting of rice, millet, corn, wheat, oat, barley, sorghum, and mixtures thereof.

18. The method according to claim 1, wherein the meat is selected from chicken, pork, beef, lamb, duck, seafood, and mixtures thereof.

19. A method for preparing meat-containing puffed food comprising:
feeding the meat-containing puffed pellet of claim 1 into a chamber of a pressure-molding apparatus;
exposing the meat-containing puffed pellet to an increased pressure and temperature inside the chamber for a selected period of time; and
rapidly expanding the volume of the chamber to cause a rapid expansion of the contained meat-containing puffed pellet to obtain a meat-containing puffed chip puffed food.

20. A meat-containing puffed pellet that comprises about 5 wt. % to about 60 wt. % of grains, about 5 wt. % to about 60 wt. % of meat, about 0 wt. % to about 20 wt. % of beans, about 0 wt. % to about 25 wt. % of protein powder, and about 0 wt. % to about 45 wt. % of edible starch.
